(19) United States
(12) Patent Application Publication
(10) Pub. No.: US 2026/0287341 A1
(43) Pub. Date: Sep. 24, 2026

(54) MEASURING POSITION OF GRAPHICS ON GARMENT PATTERN

(71) Applicant: CLO Virtual Fashion Inc., Seoul (KR)

(72) Inventors: Phoebe GATTA, New York, NY (US); Ho Hyun LEE, Seoul (KR); Wonseop LEE, Seoul (KR)

(21) Appl. No.: 19/639,321

(22) Filed: Apr. 6, 2026

Related U.S. Application Data
(63) Continuation of application No. PCT/KR2025/003496, filed on Mar. 18, 2025.

(51) Int. Cl. G01B 21/04

(52) U.S. Cl. CPC G01B 21/04

(57) ABSTRACT

Disclosed are an apparatus and a method of measuring a position of a graphic disposed on a garment pattern. According toa an embodiment, the method includes determining a measure point in a first-type entity included in a garment pattern, determining a measure point in a second-type entity included in the garment pattern, wherein the measure point intersects a straight line parallel to a predetermined axis passing through the measure point in the first-type entity, and outputting a measurement distance between the measure point in the first-type entity and the measure point in the second-type entity.

### CROSS-REFERENCE TO RELATED APPLICATIONS

This is a bypass continuation of International PCT Application No. PCT/KR2025/003496, filed on Mar. 18, 2025, which is incorporated by reference herein in its entirety.

### TECHNICAL FIELD

The following embodiments relate to a method and apparatus for measuring a position of a graphic of a garment pattern.

### BACKGROUND ART

Garments appear three-dimensional (3D) when worn by a person, but in reality, they are closer to 2D because they are a combination of pieces of fabric cut according to a 2D pattern. In the fashion industry, computer-based garment simulation technology is widely used to develop actual garment designs. Various design elements (e.g., images, logos, patterns, accessories, etc.) are arranged in a garment, and since many entities determine the design elements, it is necessary to share accurate information, such as the position and size of the design elements, in order to accurately express the intended meaning in the pattern. Accordingly, technology that may accurately measure and store information on the arrangement of design elements necessary for garment production is required during garment design.

### SUMMARY

According to an embodiment, a method of measuring a position of a graphic disposed on a garment pattern includes determining a measure point in a first-type entity included in a garment pattern, determining a measure point in a second-type entity included in the garment pattern, wherein the measure point intersects a straight line parallel to a predetermined axis passing through the measure point in the first-type entity, and outputting a measurement distance between the measure point in the first-type entity and the measure point in the second-type entity.

When the first-type entity is a graphic region, the second-type entity may include an outline of the garment pattern, and when the first-type entity is the outline of the garment pattern, the second-type entity may include the graphic region.

The determining of the measure point in the first-type entity may include determining, based on a user input of selecting a point on the outline of the garment pattern, the selected point as the measure point in the first-type entity.

The first-type entity may be determined as the outline of the garment pattern, and the second-type entity may be determined as the graphic region.

The determining of a point in the first-type entity as a measure point may include determining, based on a user input of selecting a point in the graphic region, the selected point as the measure point in the first-type entity.

The first-type entity may be determined as the graphic region, and the second-type entity may be determined as the outline of the garment pattern.

The determining of a point in the first-type entity as the measure point may include determining a feature point extracted from the outline of the garment pattern as the measure point in the first-type entity.

The first-type entity may be determined as the outline of the garment pattern, and the second-type entity may be determined as the graphic region.

A measure point in an entity of a type corresponding to the graphic region may include at least one of a point on an outline of the graphic region, and a point in a graphic content region in the graphic region.

At least one of the measure point in the first-type entity, the measure point in the second-type entity, and the measurement distance may be stored corresponding to the garment pattern.

The method further includes storing an offset of a measure point in an entity of a type corresponding to the graphic region from a reference position in the graphic region, after at least one of a position and a size of the graphic region is changed, updating the measure point in the entity of the type corresponding to the graphic region from the reference position to a point corresponding to the stored offset, based on the updated measure point in the entity of the type corresponding to the graphic region, updating a measure point in an entity of a type corresponding to the outline of the garment pattern, and outputting an updated measurement distance between the measure point of the first-type entity and the measure point in the second-type entity.

A change in the position of the graphic region may include at least one of translation of the graphic region and rotation of the graphic region.

When the graphic region is translated, the measure point in the entity of the type corresponding to the graphic region may remain unchanged.

When the graphic region is rotated, the measure point in the entity of the type corresponding to the outline of the garment pattern may remain unchanged.

According to an embodiment, an electronic apparatus includes at least one processor and a memory storing instructions, wherein the instructions, when executed by the at least one processor, may cause the electronic apparatus to perform determining a measure point in a first-type entity included in a garment pattern, determining a measure point in a second-type entity included in the garment pattern, wherein the measure point intersects a straight line parallel to a predetermined axis passing through the measure point in the first-type entity, and outputting a measurement distance between the measure point in the first-type entity and the measure point in the second-type entity.

When the first-type entity is a graphic region, the second-type entity may include an outline of the garment pattern, and when the first-type entity is the outline of the garment pattern, the second-type entity may include the graphic region.

The determining of the measure point in the first-type entity may include determining, based on a user input of selecting a point on the outline of the garment pattern, the selected point as the measure point in the first-type entity.

The first-type entity may be determined as the outline of the garment pattern, and the second-type entity may be determined as the graphic region.

The determining of the point in the first-type entity as the measure point may include determining, based on a user input of selecting a point in the graphic region, the selected point as the measure point in the first-type entity.

The first-type entity may be determined as the graphic region, and the second-type entity may be determined as the outline of the garment pattern.

The determining of the point in the first-type entity as the measure point may include determining a feature point extracted from the outline of the garment pattern as the measure point in the first-type entity.

The first-type entity may be determined as the outline of the garment pattern, and the second-type entity may be determined as the graphic region.

A measure point in an entity of a type corresponding to the graphic region may include a point on an outline of the graphic region and a point in a graphic content region in the graphic region.

At least one of the measure point in the first-type entity, the measure point in the second-type entity, and the measurement distance may be stored corresponding to the garment pattern.

The instructions, when executed by the at least one processor, may cause the electronic apparatus to further perform storing an offset of a measure point in an entity of a type corresponding to the graphic region from a reference position in the graphic region, after at least one of a position and a size of the graphic region is changed, updating the measure point in the entity of the type corresponding to the graphic region to a point corresponding to the offset stored from the reference position, based on the measure point in the entity of the type corresponding to the graphic region, updating a measure point in an entity of a type corresponding to the outline of the garment pattern, and outputting an updated measurement distance between the measure point of the first-type entity and the measure point in the second-type entity.

A change in the position of the graphic region may include at least one of translation of the graphic region and rotation of the graphic region.

When the graphic region is translated, the measure point in an entity of a type corresponding to the graphic region may remain unchanged.

When the graphic region is rotated, the measure point in an entity of a type corresponding to the outline of the garment pattern may remain unchanged.

### BRIEF DESCRIPTION OF DRAWINGS

FIG. 1 is a flowchart of a method of measuring a position of a graphic disposed on a garment pattern, according to an embodiment.

FIGS. 2A and 2B are diagrams illustrating a graphic of a garment pattern according to an embodiment.

FIGS. 3A-3C are diagrams illustrating a screen of an interface for determining a measure point, according to an embodiment.

FIG. 4 is a diagram of an example of a screen of an interface for determining a measure point, according to an embodiment.

FIGS. 5A-5C are diagrams illustrating an operation of updating a measurement distance after a graphic region is changed, according to an embodiment.

FIGS. 6A-6D are diagrams illustrating an operation of updating a measurement distance after a graphic region is changed, according to an embodiment.

FIG. 7 is a diagram illustrating an operation of determining whether a position of a graphic region in a pattern is specified by a measurement distance, according to an embodiment.

FIG. 8 is a diagram illustrating an operation of updating a measure point by changing a measurement line segment, according to an embodiment.

FIG. 9 is a diagram illustrating a settings window of a graphic region, according to an embodiment.

FIG. 10 is an example of a configuration of an apparatus according to an embodiment.

### DETAILED DESCRIPTION

The following structural or functional descriptions of embodiments are provided as examples only, and various alterations and modifications may be made to the embodiments. Accordingly, the embodiments are not construed as limited to the disclosure and should be understood to include all changes, equivalents, and replacements within the idea and the technical scope of the disclosure.

With regard to the description of the drawings, similar reference numerals may be used to refer to similar or related components. It is to be understood that a singular form of a noun corresponding to an item may include one or more of the things, unless the relevant context clearly indicates otherwise.

As used herein, "A or B", "at least one of A and B", "at least one of A or B", "A, B or C", "at least one of A, B and C", and "at least one of A, B, or C," each of which may include any one of the items listed together in the corresponding one of the phrases, or all possible combinations thereof.

Terms such as "1st", "2nd", or "first" or "second" may be used to simply distinguish a corresponding component from other components, and do not limit the components in other aspects (e.g., importance or order). For example, a first component may be referred to as a second component, and similarly the second component may also be referred to as the first component.

It is to be understood that if a component (e.g., a first component) is referred to, with or without the term "operatively" or "communicatively," as "coupled with," "coupled to," "connected with," or "connected to" another component (e.g., a second component), the component may be coupled with the other component directly (e.g., by wire), wirelessly, or via a third component.

The singular forms "a", "an", and "the" are intended to include the plural forms as well, unless the context clearly indicates otherwise. It will be further understood that the terms "comprises/comprising" and/or "includes/including" when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms used herein including technical or scientific terms have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments are described in detail with reference to the accompanying drawings. When describing the embodiments with reference to the accompanying drawings, like reference numerals refer to like elements and a repeated description related thereto will be omitted.

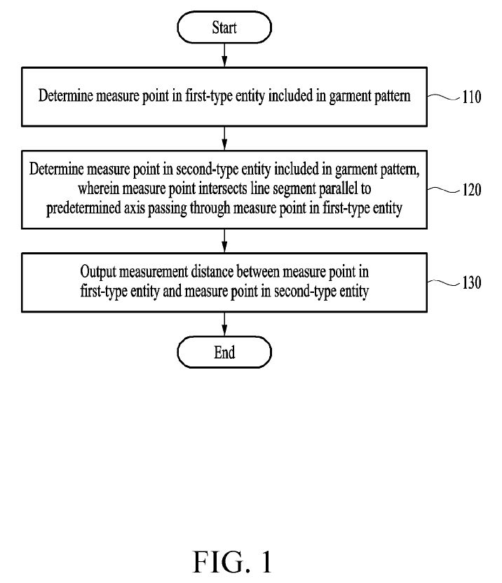

FIG. 1 is a flowchart of a method of measuring a position of a graphic disposed on a garment pattern, according to an embodiment.

A method of measuring a position of a graphic disposed on a garment pattern according to an embodiment described in FIG. 1 may be performed by a processor of an electronic apparatus. The specific hardware configuration of the electronic apparatus is described in detail below.

Operations 110 to 130 included in the method of measuring the position of a graphic disposed on a garment pattern described in FIG. 1 may be performed sequentially but not necessarily. For example, the order of operations 110 to 130 may change, and at least two operations may be performed in parallel.

The method of measuring the position of a graphic disposed on a garment pattern according to an embodiment may be briefly referred to as the "method" hereinafter.

In general, a garment pattern is a paper pattern used to cut a material to produce a garment. Herein, the garment pattern may correspond to a garment pattern on a two-dimensional (2D) plane that is virtually produced by a computer program. The garment pattern may be, for example, garment patterns used to produce a virtual garment that a user may desire to drape around a 3D avatar. There may be one or more garment patterns to produce one garment.

A garment pattern according to an embodiment may be a virtual 2D garment pattern modeled as a sum of numerous polygonal meshes for simulation of a 3D virtual garment. Vertices of a mesh may be point masses, and sides of the mesh may be represented as springs with elasticity that connects the point masses. Patterns may be modeled, for example, by a mass-spring model. Here, the springs may have respective resistance values against, for example, stretch, shear, and bending, depending on a physical property of fabric used. Each vertex may move according to the action of an external force, such as gravity, and the action of an internal force, such as stretch, shear, and bending. When a force being applied to each vertex is obtained by calculating the external force and the internal force, the speed of movement and displacement of each vertex may be obtained. Also, a movement of a virtual garment may be simulated through movements of the vertices of the mesh in each time step. By draping 2D virtual garment patterns formed with a triangle mesh around a 3D avatar, it may be possible to embody a 3D virtual garment that looks natural based on the laws of physics.

The method according to an embodiment may include operation 110 of determining a measure point in a first-type entity included in a garment pattern.

The method according to an embodiment may include operation 120 of determining a measure point in a second-type entity included in the garment pattern, wherein the measure point intersects a straight line parallel to a predetermined axis passing through the measure point in the first-type entity.

The garment pattern may include a plurality of types of entities. For example, an entity included in the garment pattern may include a graphic region and an outline of the garment pattern. The garment pattern may include various types of entities, but hereinafter, the plurality of types of entities are described as an example of a graphic region and an outline of the garment pattern.

The outline of the garment pattern may be the boundary or border of a 2D surface corresponding to the garment pattern and may include a straight line, a curve, or a combination thereof. The graphic region may be a region that includes a graphic or an image disposed on the garment pattern and may include, for example, a polygonal region or a circular region that includes all graphics. The graphic region may include the outline of the graphic region. The graphic region may include an actual graphic portion within the graphic region. The actual graphic portion may be referred to as a graphic content region.

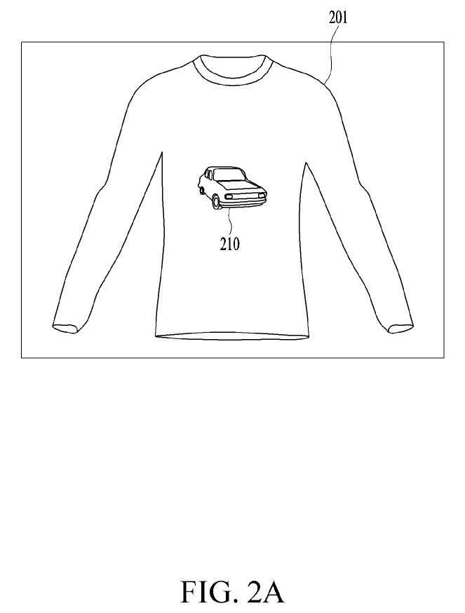

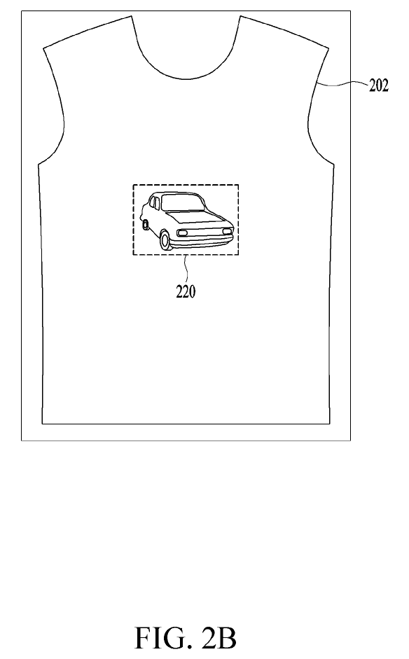

For example, referring to FIG. 2A, a garment 201 may include a graphic 210 printed or attached to the fabric. FIG. 2B is a diagram illustrating a garment pattern 202 in which the graphic 210 is disposed on the garment 201 illustrated in FIG. 2A. The garment pattern 202 may correspond to a 2D plane. For example, a graphic region 220 within the garment pattern 202 may be a rectangular region that includes all graphics.

Referring back to FIG. 1, the graphic region and the outline of the garment pattern may correspond to different types of entities. A first-type entity may be a graphic region or the outline of a garment pattern. A second-type entity may be a type of entity different from the first-type entity. For example, when the first-type entity is a graphic region, the second-type entity may include the outline of a garment pattern. For example, when the first-type entity is the outline of a garment pattern, the second-type entity may include a graphic region.

A measure point may be a point that serves as a reference for measuring the position of a graphic. At least one point included in the first-type entity may be determined as the measure point in the first-type entity. When the first-type entity is a graphic region, a point on the outline of the graphic region may be determined as the measure point in the first-type entity. When the first-type entity is a graphic region, a point within the graphic region may be determined as the measure point in the first-type entity. For example, a point on the outline of a graphic content region may be determined as the measure point in the first-type entity. When the first-type entity is the outline of a garment pattern, a point on the outline of the garment pattern may be determined as the measure point in the first-type entity.

According to an embodiment, the measure point in the first-type entity may be determined based on a user input. An entity to which a point selected by the user input belongs may be determined as the first-type entity, and the point selected by the user input may be determined as the measure point in the first-type entity.

For example, operation 110 of determining the measure point in the first-type entity may include an operation of determining, based on a user input of selecting a point on the outline of the garment pattern, the selected point as the measure point in the first-type entity. In this case, the first-type entity may be determined as the outline of the garment pattern, and the second-type entity may be determined as the graphic region. In other words, when the user input of selecting the point on the outline of the garment pattern is received, the first-type entity may be determined as the outline of the garment pattern, and the second-type entity may be determined as the graphic region.

For example, operation 110 of determining the measure point in the first-type entity may include determining, based on a user point of selecting a point in the graphic region, the selected point as the measure point in the first-type entity. In this case, the first-type entity may be determined as the graphic region, and the second-type entity may be determined as the outline of the garment pattern. In other words, when the user input of selecting the point in the graphic region is received, the first-type entity may be determined as the graphic region, and the second-type entity may be determined as the outline of the garment pattern.

According to an embodiment, the measure point in the first-type entity may be determined as at least one of feature points extracted from the first-type entity. A feature point may correspond to a point that is determined to be important in garment production or garment design. For example, a feature point of an entity of a type corresponding to the outline of the garment pattern may include a point corresponding to a vertex of the outline of the garment, both end points of an armhole line, a notch, and the like. For example, a feature point of an entity of a type corresponding to the graphic region may include a point corresponding to a vertex of the graphic region, a vertex of the graphic content region, and the like.

For example, the operation of determining the point in the first-type entity as the measure point may include an operation of determining a feature point extracted from the outline of the garment pattern as the measure point in the first-type entity. In this case, the first-type entity may be determined as the outline of the garment pattern, and the second-type entity may be determined as the graphic region. At least some of the feature points extracted from the outline of the garment pattern, such as the vertex of the outline of the garment pattern, both end points of the armhole line, both end points of the shoulder line, and the notch, may be determined as the measure point in the first-type entity.

A predetermined axis is an axis corresponding to a predetermined direction or straight line and may include, for example, a plurality of axes in different directions on a plane.

For example, the predetermined axis may include at least one of a first axis and a second axis, wherein the first axis may correspond to a horizontal axis and the second axis may correspond to a vertical axis. More particularly, for example, when a garment pattern is positioned on an xy plane, the first axis may correspond to the x-axis and the second axis may correspond to the y-axis. When the first axis is the x-axis and the second axis is the y-axis, a straight line parallel to the first axis passing through the measure point in the first-type entity may correspond to a horizontal line passing through the measure point in the first-type entity, and a straight line parallel to the second axis passing through the measure point in the first-type entity may correspond to a vertical line passing through the measure point in the first-type entity.

Although the predetermined axis may include various axes, hereinafter, an example in which the predetermined axis includes the first axis corresponding to the x-axis and the second axis corresponding to the y-axis on the xy plane is described.

For example, when the first-type entity is the graphic region, at least one of a point on the outline of the garment pattern that intersects a horizontal line generated from a measure point in the graphic region and a point on the outline of the garment pattern that intersects a vertical line generated from the measure point in the graphic region may be determined as the measure point in the second-type entity.

For example, when the first-type entity is the outline of the garment pattern, at least one of a point in the graphic region that intersects a horizontal line generated from the measure point within the outline of the garment pattern and a point in the graphic region that intersects a vertical line generated from the measure point within the outline of the garment pattern may be determined as the measure point in the second-type entity.

Hereinafter, a straight line parallel to the predetermined axis passing through the measure point in the first-type entity may be referred to as a measurement line. A straight line parallel to the first axis passing through the measure point in the first-type entity may be referred to as a first measurement line, and a straight line parallel to the second axis passing through the measure point in the second-type entity may be referred to as a second measurement line.

According to an embodiment, at least one of a point intersecting the first measurement line and a point intersecting the second measurement line among point(s) included in the second-type entity may be determined as the measure point in the second-type entity.

For example, when the point intersecting the second measurement line does not exist in the second-type entity, the point intersecting the first measurement line among the point(s) included in the second-type entity may be determined as the measure point in the second-type entity. For example, when the point intersecting the first measurement line does not exist in the second-type entity, the point intersecting the second measurement line among the point(s) included in the second-type entity may be determined as the measure point in the second-type entity. For example, when a line segment in the first-type entity to which the measure point in the first-type entity belongs is included in the second measurement line, the point intersecting the first measurement rather than the second measurement line among the point(s) included in the second-type entity may be determined as the measure point in the second-type entity. For example, when a line segment in the first-type entity to which the measure point in the first-type entity belongs is included in the first measurement line, the point intersecting the second measurement line rather than the first measurement line among the point(s) included in the second-type entity may be determined as the measure point in the second-type entity.

When the second-type entity includes a plurality of points intersecting the first measurement line and/or the second measurement line, at least some of the plurality of points may be determined as the measure point in the second-type entity. For example, when the second-type entity includes a plurality of points intersecting the first measurement line and/or the second measurement line, a point that is closest to the measure point in the first-type entity may be determined as the measure point in the second-type entity.

A plurality of measure points in the first-type entity may be determined, and one or more measure points in the second-type entity respectively corresponding to the plurality of measure points in the first-type entity may be determined. A measure point in the second-type entity may form a pair with a measure point in the first-type entity, and the measure point in the second-type entity may be connected to the measure point in the first-type entity through the first measurement line. In addition, the measure point in the second-type entity may form a pair with the measure point in the first-type entity, and the measure point in the second-type entity may be connected to the measure point in the first-type entity through the second measurement line.

The method according to an embodiment may include operation 130 of outputting a measurement distance between the measure point in the first-type entity and the measure point in the second-type entity. The measurement distance between the measure point in the first-type entity and the measure point in the second-type entity may be a straight-line distance between the measure point in the first-type entity and the measure point in the second-type entity and may be determined based on the scale of the garment pattern.

As described above, the measure point in the first-type entity may form a pair with the measure point in the second-type entity. The distance between the measure point in the first-type entity and the measure point in the second-type entity, which form a pair, may be determined as the measurement distance.

According to an embodiment, at least one of the measure point in the first-type entity, the measure point in the second-type entity, and the measurement distance may be stored corresponding to the garment pattern.

The measurement distance may be used to determine the position of a graphic to dispose the graphic on the garment pattern. The graphic region may be disposed on the garment pattern using the measurement distance between the measure point in the graphic region stored corresponding to the garment pattern and the measure point within the outline of the garment pattern.

A plurality of measurement distances may be required to determine the position at which the graphic region is disposed. A method of determining whether obtained measurement distances are sufficient to determine the position at which the graphic region is disposed is described in detail below.

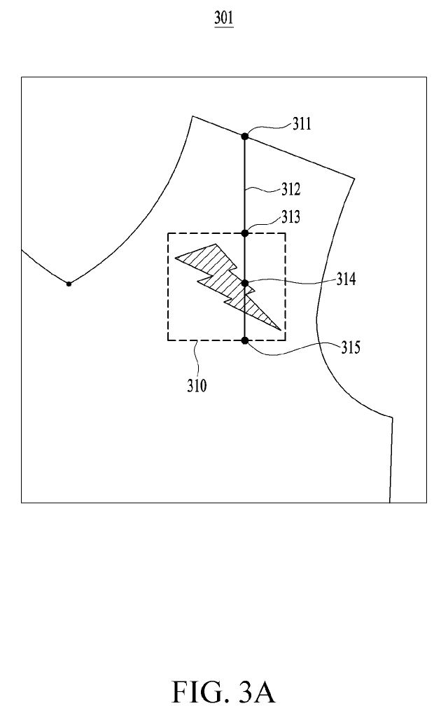

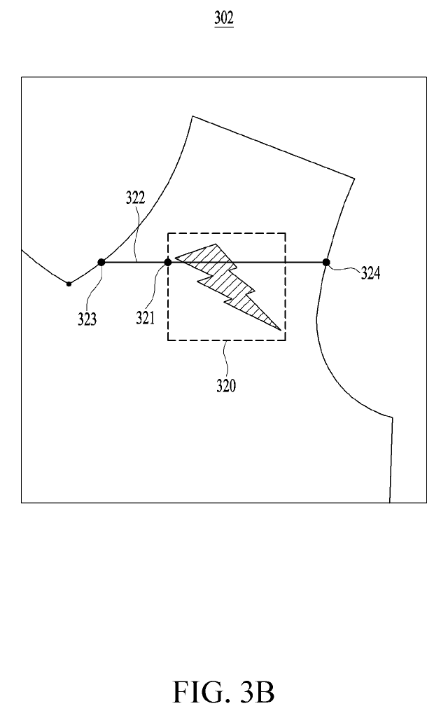

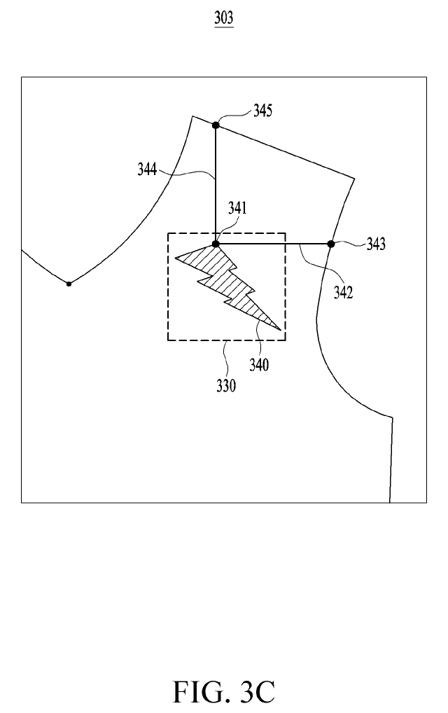

FIGS. 3A-3C are diagrams illustrating a screen of an interface for determining a measure point, according to an embodiment.

A screen 301 of FIG. 3A, a screen 302 of FIG. 3B, and a screen 303 of FIG. 3C are interface screens on which a graphic may be disposed on a garment pattern. For example, the screen 301 of FIG. 3A, the screen 302 of FIG. 3B, and the screen 303 of FIG. 3C may be screens that are output to a terminal of a user. The terminal of the user may be an electronic apparatus that performs the method described above with reference to FIG. 1.

Referring to FIG. 3A, a point 311 selected by an input of selecting (e.g., clicking) the point 311 on the outline of a garment pattern may be determined as a measure point in a first-type entity. When the input of selecting the point 311 on the outline of the garment pattern is received, the outline of the garment pattern may be determined as the first-type entity, and the selected point 311 on the outline of the garment pattern may be determined as the measure point in the first-type entity. When the outline of the garment pattern is determined as the first-type entity by the input of selecting the point 311 on the outline of the garment pattern, the graphic region 310 may be determined as a second-type entity.

For example, when a straight line 312 passing through the point 311 determined as the measure point in the first-type entity and parallel to the y-axis is generated, a point 313 on the outline of the graphic region 310 intersecting the generated straight line 312 may be determined as a measure point in the second-type entity. For example, a point 314 on a graphic content region intersecting the generated straight line 312 may be determined as the measure point in the second-type entity. Meanwhile, a straight line passing through the point 311 determined as the measure point in the first-type entity and parallel to the x-axis may not have an intersection with the graphic region 310.

According to an embodiment, based on the ratio of a graphic content region within the graphic region 310, the measure point in the second-type entity is determined as the point 313 on the outline of the graphic region 310 or the point 314 of the graphic content region. For example, when the ratio of the graphic content region within the graphic region 310 is less than or equal to a threshold value, the point 314 in the graphic content region may be determined as the measure point in the second-type entity, and when the ratio of the graphic content region within the graphic region 310 is greater than the threshold value, the point 313 on the outline of the graphic region 310 may be determined as the measure point in the second-type entity.

For example, a portion corresponding to graphic content in the graphic region 310 may be determined based on the transparency of each pixel. In the graphic region 310, a portion with transparency greater than a threshold value may be determined as a background of a graphic, and a portion with transparency less than the threshold value may be determined as the portion corresponding to the graphic content.

For example, the portion corresponding to the graphic content in the graphic region 310 may be determined based on the contrast between pixels. A portion in which the contrast between adjacent pixels in the graphic region 310 is greater than or equal to a threshold value may be determined as a boundary portion of the graphic content in the graphic region 310. It may be determined that the region inside the boundary determined based on the contrast between adjacent pixels is the portion corresponding to the graphic content and that the region outside the boundary is the background of the graphic.

There may be a plurality of points in the graphic region 310 intersecting the straight line 312. For example, among a plurality of points 313 and 315 on the outline of the graphic region 310 intersecting the straight line 312, a point that is closest to the measure in the first-type entity or a point selected by a user input may be determined as the measure point in the second-type entity. For example, the point selected by the user input among the plurality of points on the outline of the graphic region 310 intersecting the straight line 312 and/or the point in the graphic content may be determined as the measure point in the second-type entity.

Referring to FIG. 3B, a point 321 selected by an input of selecting (e.g., clicking) the point 321 on the outline of a graphic region 320 may be determined as the measure point in the first-type entity. When the input of selecting the point 321 on the outline of the graphic region 320 is received, the graphic region 320 may be determined as the first-type entity, and the selected point 321 on the outline of the graphic region may be determined as the measure point in the first-type entity. When the graphic region 320 is determined as the first-type entity by the input of selecting the point 321 on the outline of the graphic region 320, the outline of the garment pattern may be determined as the second-type entity.

When a straight line 322 passing through the point 321 determined as the measure point in the first-type entity and parallel to the x-axis is generated, a point 323 on the outline of the garment pattern intersecting the generated straight line 322 may be determined as the measure point in the second-type entity.

There may be a plurality of points on the outline of the garment pattern intersecting the straight line 322. For example, among a plurality of points 323 and 324 on the outline of the garment pattern intersecting the straight line 322, a point that is closest to the measure point in the first-type entity and a point selected by a user input may be determined as the measure point in the second-type entity.

Referring to FIG. 3C, when an input of selecting a point 341 on graphic content 340 in a graphic region 330 is received, the graphic region 330 may be determined as the first-type entity, and the selected point 341 on the graphic content 340 may be determined as the measure point in the first-type entity. When the graphic region 330 is determined as the first-type entity by the input of selecting the point 341 on the graphic content 340, the outline of the garment pattern may be determined as the second-type entity.

When a straight line 342 passing through the point 341 determined as the measure point in the first-type entity and parallel to the x-axis is generated, a point 343 on the outline of the garment pattern intersecting the generated straight line 342 may be determined as the measure point in the second-type entity.

When a straight line 344 passing through the point 341 determined as the measure point in the first-type entity and parallel to the y-axis is generated, a point 345 on the outline of the garment pattern intersecting the generated straight line 344 may be determined as the measure point in the second-type entity.

There may be a plurality of points on the outline of the garment pattern intersecting the straight line 342 or the straight line 344. For example, a plurality of points 343 and 345 on the outline of the garment pattern intersecting the straight line 342 or the straight line 344 may all be determined as measure points in the second-type entity. For example, among the plurality of points 343 and 345 on the outline of the garment pattern intersecting the straight line 342 or the straight line 344, a point that is closest to the measure point in the first-type entity and a point selected by a user input may be determined as the measure point in the second-type entity.

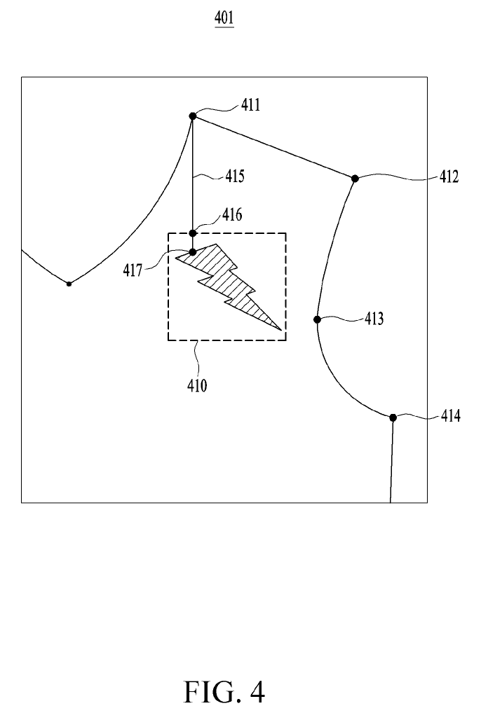

FIG. 4 is a diagram illustrating a screen of an interface for determining a measure point, according to an embodiment.

A screen 401 of FIG. 4 may be an example of an interface screen on which a graphic is disposed on a garment pattern. For example, the screen 401 of FIG. 4 may be a screen output to a terminal of a user. The terminal of the user may be an electronic apparatus that performs the method described above with reference to FIG. 1.

Referring to FIG. 4, a feature point extracted from the outline of the garment pattern may be determined as a measure point in a first-type entity. Feature points extracted from the outline of the garment pattern may include a first feature point 411 and a second feature point 412 corresponding to the end points of the shoulder line of the garment pattern, the second feature point 412 and a fourth feature point 414 corresponding to the end points of the armhole line, and a third feature point 413 corresponding to a notch.

At least some of the feature points extracted from the outline of the garment pattern may be determined as candidates for a measure point in the first-type entity. For example, among the feature points extracted from the outline of the garment pattern, a feature point intersecting a graphic region 410 may be determined as a candidate for the measure point in the first-type entity. The feature point intersecting the graphic region 410 may be a feature point intersecting the graphic region 410, which is a second-type entity, when a straight line parallel to a first axis or a second axis is drawn from the feature point.

For example, among the feature points provided as candidates for the measure point in the first-type entity, a feature point selected by a user input may be determined as the measure point in the first-type entity.

A straight line passing through a first feature point 411 and parallel to the y-axis intersects the graphic region 410, so the first feature point 411 may be determined as the measure point in the first-type entity. For example, when a user input of selecting the first feature point 411 is received, the first feature point 411 may be determined as the measure point in the first-type entity.

A straight line passing through the fourth feature point 414 and parallel to the x-axis may not intersect the graphic region 410. The candidates for the measure point in the first-type entity may not include the fourth feature point 414.

A feature point that may be determined as the measure point in the first-type entity may be marked so as to be distinguished from other portions on the outline of the garment pattern, such as by being highlighted.

For example, the first feature point 411 selected by an input of selecting (e.g., clicking) the first feature point 411 extracted from the outline of the garment pattern may be determined as the measure point in the first-type entity. When a straight line 415 passing through the first feature point 411 determined as the measure point in the first-type entity and parallel to the y-axis is generated, a point 416 on the outline of the graphic region 410 intersecting the generated straight line 415 may be determined as a measure point in a second-type entity. For example, a point 417 on a graphic content region intersecting the generated straight line 415 may be determined as the measure point in the second-type entity.

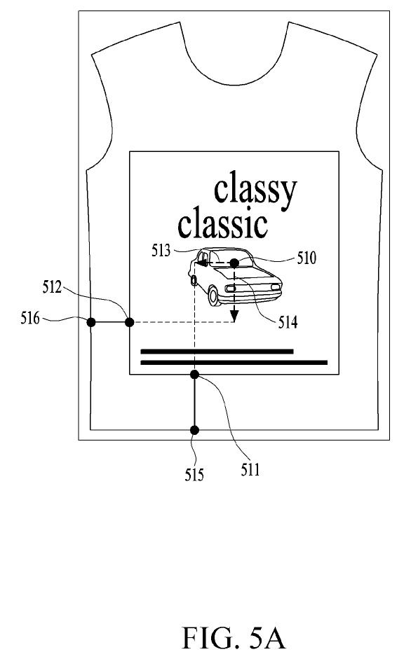

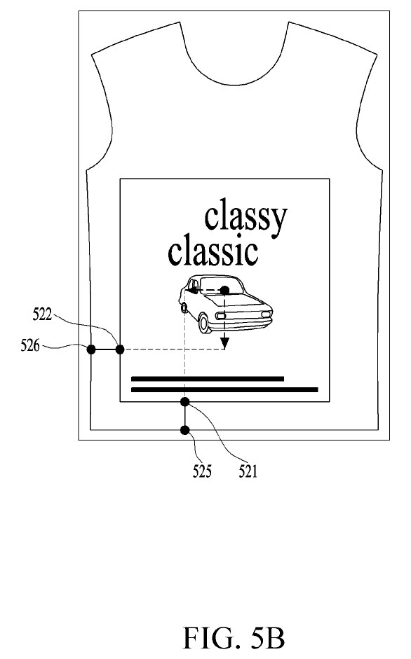

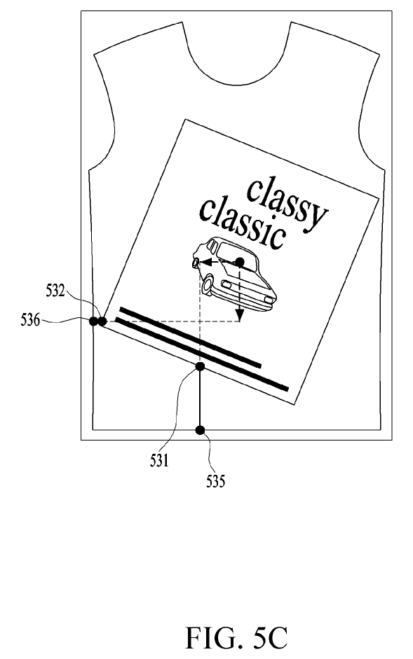

FIGS. 5A-5C are diagrams illustrating an operation of updating a measurement distance after a graphic region is changed, according to an embodiment.

The method according to an embodiment may include an operation of storing an offset of a measure point in an entity of a type corresponding to a graphic region from a reference position in the graphic region, an operation of updating the measure point in the entity of the type corresponding to the graphic region to a point corresponding to the offset stored from the reference position after at least one of a position and a size of the graphic region is changed, an operation of updating a measure point in an entity of a type corresponding to an outline of a garment pattern based on the updated measure point in the entity of the type corresponding to the graphic region, and an operation of outputting a measurement distance between a measure point in a first-type entity and a measure point in a second-type entity.

The reference position in the graphic region may be a particular, predetermined location in the graphic region, such as the center of the graphic region. An offset of a measure point in the graphic region from the reference position may include the x-axis position or the y-axis position of the measure point in the graphic region from the reference position.

For example, referring to FIG. 5A, the offset may include a displacement 513 on the x-axis of a first measure point 511 in the graphic region and a center 510 of the graphic region. Information indicating that the first measure point 511 in the graphic region is a point on a first side or a bottom side, which is located at the bottom of the outline of the graphic region, may also be stored. The offset may include a displacement 514 on the y-axis of a second measure point 512 in the graphic region and the center 510 of the graphic region. Information indicating that the second measure point 512 in the graphic region is a point on a second side or a left side, which is located on the left side of the outline of the graphic region, may also be stored.

A measure point within the outline of the garment pattern may be determined based on a measure point in the graphic region. For example, a point on the outline of the garment pattern that passes through the first measure point 511 in the graphic region and intersects a straight line parallel to the y-axis may be determined as a third measure point 515 within the outline of the garment pattern. The distance between the first measure point 511 in the graphic region and the third measure point 515 within the outline of the garment pattern may be measured. The measurement distance between the first measure point 511 in the graphic region and the third measure point 515 within the outline of the garment pattern may be output through an interface.

For example, a point on the outline of the garment pattern that passes through the second measure point 512 in the graphic region and intersects a straight line parallel to the x-axis may be determined as a fourth measure point 516 within the outline of the garment pattern. The distance between the second measure point 512 in the graphic region and the fourth measure point 516 within the outline of the garment pattern may be measured. The measurement distance between the second measure point 512 in the graphic region and the fourth measure point 516 within the outline of the garment pattern may be output through the interface.

A change in the position of the graphic region may include at least one of translation of the graphic region and rotation of the graphic region.

FIG. 5B illustrates a graphic region disposed on a garment pattern after the graphic region is translated. For example, when the position of the graphic region of FIG. 5A is an initial position, referring to FIG. 5B, the graphic region may be translated within the region of the garment pattern. After the graphic region is translated, a measure point in the graphic region may be updated to a point corresponding to an offset stored from a reference position. More specifically, a first measure point 521 in the graphic region may be updated to a point on the bottom side that is spaced apart from the center of the graphic region by displacement 513. A second measure point 522 in the graphic region may be updated to a point on the left side that is spaced apart from the center of the graphic region by the displacement 514 on the y-axis.

A measure point within the outline of the garment pattern may be updated based on an updated measure point in the graphic region.

For example, a point on the outline of the garment pattern that passes through the first measure point 521 in the graphic region and intersects a straight line parallel to the y-axis may be determined as a third measure point 525 within the outline of the garment pattern. Referring to FIGS. 5A and 5B, in the garment pattern, the position of the third measure point 515 within the outline of the garment pattern before the translation may be different from the position of the third measure point 525, which is updated after the translation, within the outline of the garment pattern.

For example, a point on the outline of the garment pattern that passes through the second measure point 522 in the graphic region and intersects a straight line parallel to the x-axis may be determined as a fourth measure point 526 within the outline of the garment pattern. Referring to FIGS. 5A and 5B, in the garment pattern, the position of the fourth measure point 516 within the outline of the garment pattern before the translation may be different from the position of the fourth measure point 526, which is updated after the translation, within the outline of the garment pattern.

A measurement distance may be updated by updated measure points. For example, the distance between the updated first measure point 521 in the graphic region and the updated third measure point 525 within the outline of the garment pattern may be measured. An updated measurement distance between the updated first measure point 521 in the graphic region and the updated third measure point 525 within the outline of the garment may be output through an interface. For example, the distance between the updated second measure point 522 in the graphic region and the updated fourth measure point 526 within the outline of the garment pattern may be measured. An updated measurement distance between the updated second measure point 522 in the graphic region and the updated fourth measure point 526 within the outline of the garment may be output through an interface.

Referring to FIGS. 5A and 5B, when a change in the position of the graphic region is translation of the graphic region, a measure point in an entity of a type corresponding to the graphic region may remain unchanged. In other words, the local coordinates or the relative position of the first measure point 511 in the graphic region before the translation may be the same as the first measure point 521, which is updated after the translation, in the graphic region. The local coordinates or the position of the second measure point 512 in the graphic region before the translation may be the same as the second measure point 522, which is updated after the translation, in the graphic region.

FIG. 5C illustrates a graphic region disposed on a garment pattern after the graphic region is rotated. For example, when the position of the graphic region of FIG. 5A is an initial position, referring to FIG. 5C, the graphic region may be rotated within a garment pattern region. In other words, the graphic region may be rotated while the center position of the graphic region is maintained. After the graphic region is rotated, a measure point in the graphic region may be updated to a point corresponding to an offset stored from a reference position. More specifically, the first measure point 531 in the graphic region may be updated to a point on the bottom side that is spaced apart from the center of the graphic region by the distance 513 on the x-axis. A second measure point 532 in the graphic region may be updated to a point on the left side that is spaced apart from the center of the graphic region by the displacement 514 on the y-axis.

A measure point within the outline of the garment pattern may be updated based on an updated measure point in the graphic region. For example, a point on the outline of the garment pattern that passes through the first measure point 531 in the graphic region and intersects a straight line parallel to the y-axis may be determined as a third measure point 535 within the outline of the garment pattern. For example, a point on the outline of the garment pattern that passes through the second measure point 532 in the graphic region and intersects a straight line parallel to the x-axis may be determined as a fourth measure point 536 within the outline of the garment pattern.

A measurement distance may be updated by updated measure points. For example, the distance between the updated first measure point 531 in the graphic region and the updated third measure point 535 within the outline of the garment pattern may be measured. An updated measurement distance between the updated first measure point 531 in the graphic region and the updated third measure point 535 within the outline of the garment may be output through an interface. For example, the distance between the updated second measure point 532 in the graphic region and the updated fourth measure point 536 within the outline of the garment pattern may be measured. An updated measurement distance between the updated second measure point 532 in the graphic region and the updated fourth measure point 536 within the outline of the garment may be output through an interface.

Referring to FIGS. 5A-5C, when a change in the position of the graphic region is rotation, a measure point in an entity of a type corresponding to the outline of the garment pattern may remain unchanged. In other words, the local coordinates or the relative position of the third measure point 515 within the outline of the garment pattern before the rotation may be the same as the third measure point 535, which is updated after the rotation, within the outline of the garment pattern. The local coordinates or the position of the fourth measure point 516 on the outline of the garment pattern before the rotation may be the same as the fourth measure point 536, which is updated after the rotation, within the outline of the garment pattern.

Although not shown in the diagram, according to an embodiment, the size of the graphic region may be changed, and a measure point may be updated by the change in the size of the graphic region. The size of the graphic region may be changed to be smaller or larger. For example, when the graphic region is a rectangle, the size of the graphic region may be changed with the same width and height ratio, or the width and height ratio may also be changed. When the size of the graphic region is changed, a stored offset may be adjusted based on the ratio of the changed size of the graphic region. For example, when the width of the graphic region is doubled, the offset in the x-axis direction may be adjusted to a value that is doubled. For example, when the vertical length of the graphic region is reduced by half, an offset in the y-axis direction may be adjusted to a value that is reduced by half. After the size of the graphic region is changed, a measure point in the graphic region may be updated to a point corresponding to an offset changed from a reference position. The position of the measure point in the graphic region may be determined based on the changed size ratio. In other words, the local coordinates of the graphic region or the relative position in the graphic region of the measure point in the graphic region before resizing may not be changed even after the size of the graphic region is changed. For example, when the position of the measure point in the graphic region before resizing is the center position of the left side of the outline of the graphic region, the position of the measure point in the graphic region after the resize may also be fixed to the center position of the left side of the outline of the graphic region.

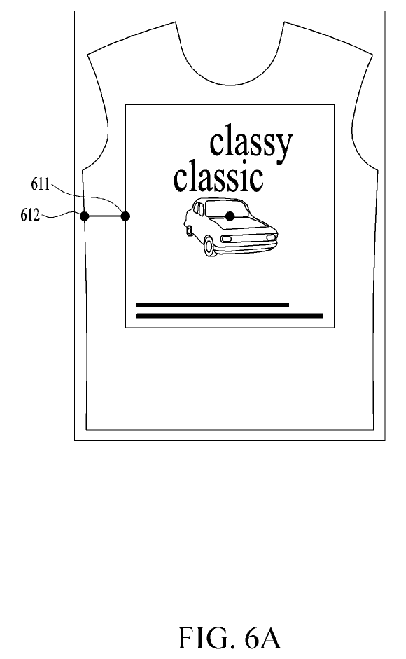

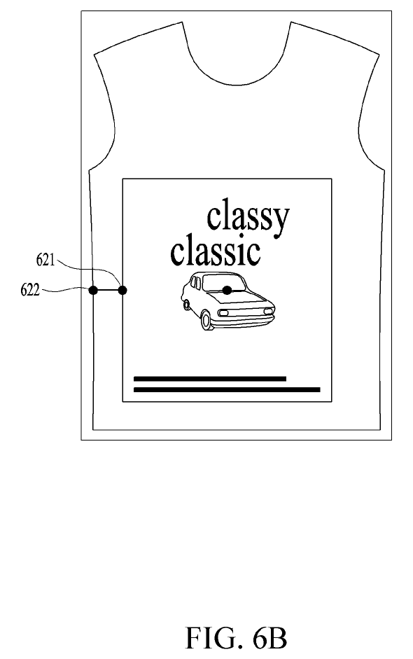

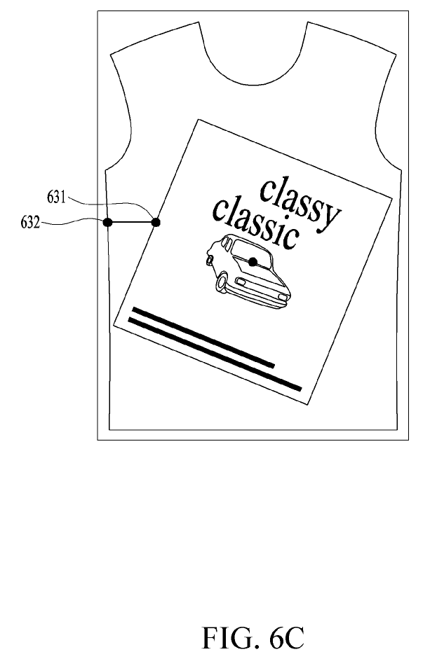

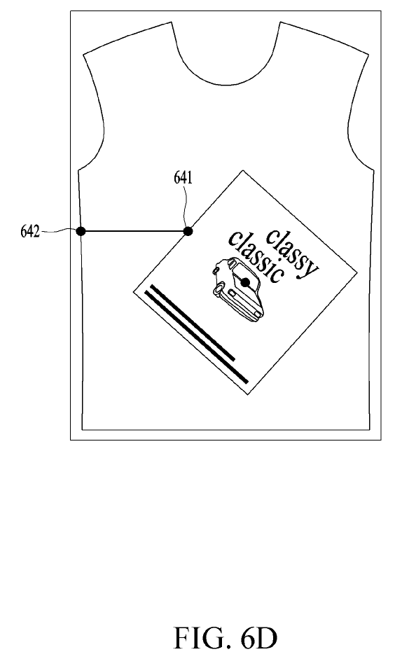

FIGS. 6A-6D are diagrams illustrating an operation of updating a measurement distance after a graphic region is changed, according to an embodiment.

The method according to an embodiment may include an operation of determining at least one of a measure point in a first-type entity and a measure point in a second-type entity as a fixed measure point, an operation of updating a measure point in an entity of a different type from an entity to which the fixed measure point belongs, wherein the measure point intersects a straight line parallel to a predetermined axis passing through the fixed measure point after the position of the graphic region is changed, and an operation of outputting an updated measurement distance between the measure point in the first-type entity and the measure point in the second-type entity.

The fixed measure point may correspond to a measure point that remains fixed as a measure point even after at least one of the position and size of the graphic region is changed. When the measure point in the first-type entity is determined as the fixed measure point, after at least one of the position and size of the graphic region is changed, the measure point in the first-type entity may not be changed, and the measure point in the second-type entity may be updated. When the measure point in the second-type entity is determined as the fixed measure point, after at least one of the position and size of the graphic region is changed, the measure point in the second-type entity may not be changed, and the measure point in the first-type entity may be updated.

A change in the position of the graphic region may include at least one of translation of the graphic region and rotation of the graphic region.

For example, referring to FIG. 6A, the center position of the left side on the left side of the outline of the graphic region may be determined as a measure point 611 in the graphic region. A point on the outline of a garment pattern that intersects a straight line passing through the measure point 611 in the graphic region and parallel to the x-axis may be determined as a measure point 612 within the outline of the garment pattern. The distance between the measure point 611 in the graphic region and the third measure point 515 within the outline of the garment pattern may be measured. The measurement distance between the first measure point 511 in the graphic region and the third measure point 515 within the outline of the garment pattern may be output through an interface.

FIG. 6B illustrates the graphic region disposed on the garment pattern after the graphic region is translated. For example, when the position of the graphic region of FIG. 6A is an initial position, referring to FIG. 6B, the graphic region may be translated within the region of the garment pattern. Referring to FIGS. 6A and 6B, when the measure point 611 in the graphic region is determined as a fixed measure point, even after the graphic region is translated, the position of a measure point 621 in the graphic region may be the same as the position of the measure point 611 in the graphic region before translation.

When the position of the graphic region is changed, a point on the outline of the garment pattern intersecting a straight line parallel to the x-axis and passing through the measure point 621 in the graphic region may be updated to a measure point 622 within the outline of the garment pattern. When compared to the position of the measure point 612 within the outline of the garment pattern before the graphic region is translated, the position of the measure point 622 within the outline of the garment pattern after the graphic region is translated may be changed due to the change in the position of the graphic region.

A measurement distance may be updated by updated measure points. For example, the distance between the updated measure point 621 in the graphic region and the updated measure point 622 within the outline of the garment pattern may be measured. An updated measurement distance between the updated measure point 621 in the graphic region and the measure point 622 within the outline of the garment pattern may be output through an interface.

FIG. 6C illustrates the graphic region disposed on the garment pattern after the graphic region is rotated. For example, when the position of the graphic region of FIG. 6A is the initial position, referring to FIG. 6C, the graphic region may be rotated within the region of the garment pattern. Referring to FIGS. 6A and 6C, when the measure point 611 in the graphic region is determined as the fixed measure point, even after the graphic region is rotated, a position 631 of a measure point in the graphic region may be the same as the position of the measure point 611 in the graphic region before rotation.

When the position of the graphic region is changed, a point on the outline of the garment pattern intersecting a straight line parallel to the x-axis and passing through the measure point 621 in the graphic region may be updated to a measure point 632 within the outline of the garment pattern. When compared to the position of the measure point 612 within the outline of the garment pattern before the graphic region is rotated, the position of the measure point 632 within the outline of the garment pattern after the graphic region is rotated may be changed due to the change in the position of the graphic region.

A measurement distance may be updated by updated measure points. For example, the distance between the updated measure point 631 in the graphic region and the updated measure point 632 within the outline of the garment pattern may be measured. An updated measurement distance between the updated measure point 631 in the graphic region and the measure point 632 within the outline of the garment pattern may be output through an interface.

According to an embodiment, the size of the graphic region may be changed, and a measure point may be updated due to the change in the size of the graphic region. FIG. 6D illustrates the graphic region disposed on the garment pattern after the position and size of the graphic region is changed. For example, when the size of the graphic region of FIG. 6A is the initial size, referring to FIG. 6D, the size of the graphic region may be changed to be smaller. Unlike what is shown in FIG. 6D, the size of the graphic region may be changed to be larger than the initial size.

Referring to FIGS. 6A and 6D, when the measure point 611 in the graphic region is determined as a fixed measure point, after the size of the graphic region is changed, the position of a measure point 641 in the graphic region may be determined based on the changed size ratio. In other words, the local coordinates or relative position of the measure point 611 in the graphic region before resizing may not be changed even after the size of the graphic region is changed. For example, when the position of the measure point 611 in the graphic region before resizing is the center position of the left side of the outline of the graphic region, the position of the measure point 641 in the graphic region after resizing may also be fixed to the center position of the left side of the outline of the graphic region.

After the size of the graphic region is changed, a point on the outline of the garment pattern intersecting a straight line parallel to the x-axis passing through the measure point 641 in the graphic region of which the position and size are changed may be updated to a measure point 642 within the outline of the garment pattern. When compared to the position of the measure point 612 within the outline of the garment pattern before the graphic region is translated, the position of the measure point 642 within the outline of the garment pattern after the size and position of the graphic region are changed may be changed due to the change in the size and position of the graphic region.

A measurement distance may be updated by updated measure points. For example, the distance between the updated measure point 641 in the graphic region and the updated measure point 642 within the outline of the garment pattern may be measured. An updated measurement distance between the updated measure point 641 in the graphic region and the measure point 642 within the outline of the garment pattern may be output through an interface.

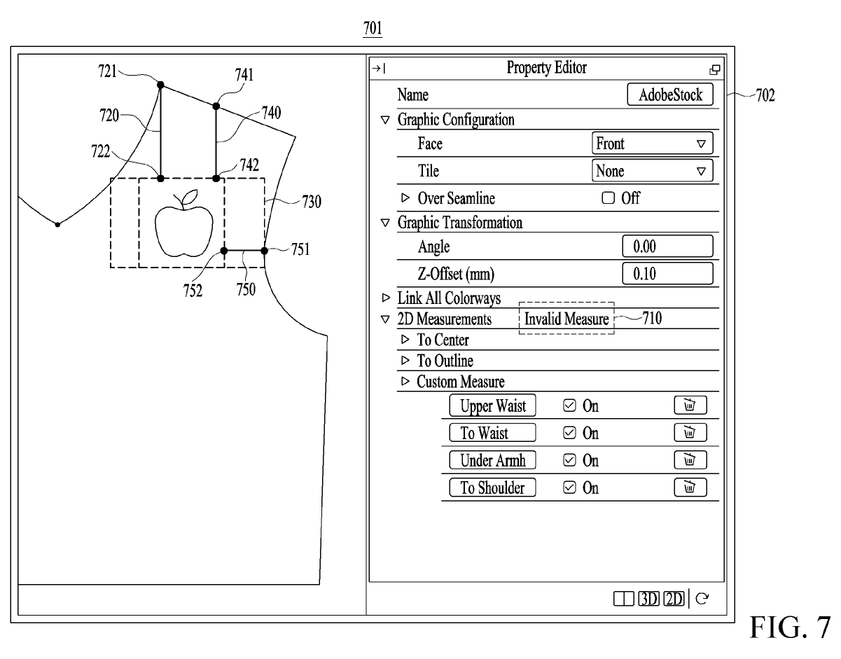

FIG. 7 is a diagram illustrating an operation of determining whether a position of a graphic region in a pattern is specified by a measurement distance, according to an embodiment.

The method according to an embodiment may include an operation of determining whether a position of a graphic region in a garment pattern is specified and an operation of outputting a result of determining whether the position of the graphic region in the garment pattern is specified.

FIG. 7 illustrates a screen 701 of an interface for editing a graphic region. For example, when a user input for determining a measure point is received, a settings window 702 of the graphic region may be displayed. The user input for determining a measure point may include, for example, an input of clicking a determined button of an input device (e.g., a mouse, a keyboard, etc.) at a point on the outline of a garment pattern. The settings window 702 of the graphic region is described in detail below.

Referring to the screen 701, based on a measurement distance through the interface for editing the graphic region, a result of determining whether the position of the graphic region in the garment pattern is specified may be output. For example, when it is determined that the position of the graphic region in the garment pattern is not specified, an interfacing object 710 indicating that the measurement distance is not valid for specifying the position of the graphic region may be added to the interface. When it is determined that the position of the graphic region in the garment pattern is specified, an interfacing object including "Valid" indicating that the measurement distance is valid for specifying the position of the graphic region may be added to the interface.

According to an embodiment, the operation of determining whether the position of the graphic region in the garment pattern is specified may include, when a rectangular graphic region is aligned with a first axis and a second axis, an operation of determining whether there are two or more sides including a measure point on the outline of the graphic region.

A case in which the rectangular graphic region is aligned with the first axis and the second axis may be a case in which each side of the graphic region is aligned parallel to the first axis or the second axis. For example, when the graphic region is not rotated from an initial state, it may be determined that the graphic region is aligned with the first axis and the second axis. For example, when the first axis is perpendicular to the second axis and the graphic region is rotated by a multiple of 90 degrees from the initial state, it may be determined that the graphic region is aligned with the first axis and the second axis. For example, when the first axis is the x-axis and the second axis is the y-axis, and when the top side and the bottom side of the outline of the rectangular graphic region are parallel to the x-axis (i.e., parallel to the horizontal line) and the left side and the right side of the outline of the rectangular graphic region are parallel to the y-axis (i.e., parallel to the vertical line), it may be determined that the graphic region is aligned with the first axis and the second axis.

According to an embodiment, corresponding to the garment pattern, a measurement line segment corresponding to a measure point within the outline of the garment pattern and a measurement distance may be stored. Position information of the measure point in the graphic region may not be stored. For example, when a first measure point 721 within the outline of the garment pattern is determined, when a straight line parallel to the y-axis is drawn from the first measure point 721 within the outline of the garment pattern, a second measure point 722 in the graphic region that intersects the straight line is determined, so the measurement distance between the first measure point 721 within the outline of the garment pattern and the second measure point 722 in the graphic region may be determined. Information on the first measure point 721 within the outline of the garment pattern and information (e.g., information indicating a direction and a length) about a first measurement line segment 720 that connects the first measure point 721 within the outline of the garment pattern to the second measure point 722 in the graphic region may be stored, while position information of the second measure point 722 in the graphic region determined by the first measure point 721 within the outline of the garment pattern may not be stored.

Based on the direction of the measurement line segment connecting the measure point within the outline of the garment pattern to the measure point in the graphic region, a side of the outline of the graphic region to which the measure point in the graphic region belongs may be determined. When the measurement line segment is directed downward from the measure point within the outline of the garment pattern, the measurement line segment may intersect the top side of outline of the graphic region, and the measure point in the graphic region may correspond to a point belonging to the top side of the graphic region. When the measurement line segment is directed upward from the measure point within the outline of the garment pattern, the measurement line segment may intersect the bottom side of the outline of the graphic region, and the measure point in the graphic region may correspond to a point belonging to the bottom side of the graphic region. When the measurement line segment is directed downward and to the right from the measure point within the outline of the garment pattern, the measurement line segment may intersect the left side of the outline of the graphic region, and the measure point in the graphic region may correspond to a point belonging to the left side of the graphic region. When the measurement line segment is to the left from the measure point within the outline of the garment pattern, the measurement line segment may intersect the right side of the outline of the graphic region, and the measure point in the graphic region may correspond to a point belonging to the right side of the graphic region.

Based on the stored information about the first measure point 721 within the outline of the pattern and the stored information about the first measurement line segment 720, the position of the graphic region in the garment pattern may be determined. When there is only one measurement distance between the graphic region and the garment pattern, which is measured from the first measure point 721 within the outline of the pattern, the graphic region may be positioned in a region 730 that is spaced apart from the first measure point 721 within the outline of the pattern by the length of the first measurement line segment 720, so the position of the graphic region in the garment pattern may not be specified as one. Therefore, when there is only one measurement distance between the graphic region and the garment pattern, the position of the graphic region may not be specified, so the interfacing object 710 indicating that the measurement distance is not valid for specifying the position of the graphic region may be added to the interface.

Even when there are two or more measurement distances between the graphic region and the garment pattern, the position of the graphic region may not be specified if the measurement distances are measured from the same side of the outline of the graphic region. For example, when the first measure point 721 and a third measure point 741 within the outline of the garment pattern is determined, when a straight line parallel to the y-axis is drawn from the first measure point 721 within the outline of the garment pattern, a second measure point 722 in the graphic region that intersects the straight line may be determined, so the measurement distance between the first measure point 721 within the outline of the garment pattern and the second measure point 722 in the graphic region may be determined. In addition, when a straight line parallel to the y-axis is drawn from the third measure point 741 within the outline of the garment pattern, a fourth measure point 742 in the graphic region that intersects the straight line may be determined, so the measurement distance between the third measure point 741 within the outline of the garment pattern and the fourth measure point 742 in the graphic region may be determined. The information on the first measure point 721 within the outline of the garment pattern, the information (e.g., information indicating a direction and a length) on the first measurement line segment 720, which is the line segment connecting the first measure point 721 within the outline of the garment pattern to the second measure point 722 in the graphic region, information on the third measure point 741 within the outline of the garment pattern, and information (e.g., information indicating a direction and a length) on the second measurement line segment 740 connecting the third measure point 741 within the outline of the garment pattern to the fourth measure point 742 in the graphic region may be stored.

Based on the stored information on the first measure point 721 within the outline of the pattern, the information on the first measurement line segment 720, the information on the third measure point 741, and the second measurement line segment 740, the position of the graphic region in the garment pattern may be determined. Even when there are two or more measurement distances between the graphic region and the garment pattern, both the first measurement line segment 720 and the second measurement line segment 740 may intersect the top side of the graphic region. Therefore, the graphic region may be positioned in the region 730 that is spaced apart from the first measure point 721 within the outline of the pattern by the length of the stored first measurement line segment 720 and spaced apart from the third measure point 741 within the outline of the pattern by the length of the stored second measurement line segment 740. Thus, the position of the graphic region in the garment pattern may not be specified as one. Therefore, when there is only one measurement distance between the graphic region and the garment pattern, the position of the graphic region may not be specified, so the interfacing object 710 indicating that the measurement distance is not valid for specifying the position of the graphic region may be added to the interface.

When there are two or more sides including a measure point on the outline of the graphic region, the position of the graphic region in the garment pattern may be specified. For example, when the first measure point 721 and a fifth measure point 751 within the outline of the garment pattern is determined, when a straight line parallel to the y-axis is drawn from the first measure point 721 within the outline of the garment pattern, a second measure point 722 in the graphic region that intersects the straight line may be determined, so the measurement distance between the first measure point 721 within the outline of the garment pattern and the second measure point 722 in the graphic region may be determined. In addition, when a straight line parallel to the x-axis is drawn from the fifth measure point 751 within the outline of the garment pattern, a sixth measure point 752 in the graphic region that intersects the straight line is determined, so the measurement distance between the fifth measure point 751 within the outline of the garment pattern and the sixth measure point 752 in the graphic region may be determined. The information on the first measure point 721 within the outline of the garment pattern, the information (e.g., information indicating a direction and a length) on the first measurement line segment 720, which is the line segment connecting the first measure point 721 within the outline of the garment pattern to the second measure point 722 in the graphic region, information on the fifth measure point 751 within the outline of the garment pattern, and information (e.g., information indicating a direction and a length) on the third measurement line segment 750 connecting the fifth measure point 751 within the outline of the garment pattern to the sixth measure point 752 in the graphic region may be stored.

Based on the stored information on the first measure point 721 within the outline of the pattern, the information on the first measurement line segment 720, the information on the fifth measure point 751, and the third measurement line segment 750, the position of the graphic region in the garment pattern may be determined. The first measurement line segment 720 intersects the top side of the graphic region, and the third measurement line segment 750 intersects the right side of the graphic region. Therefore, there are two sides that include a measure point on the outline of the graphic region, the top side and the right side. The position of the graphic region may be specified as a position that is spaced apart from the first measure point 721 within the outline of the pattern by the length of the first measurement line segment 720 and spaced apart from the fifth measure point 751 within the outline of the pattern by the length of the stored third measurement line segment 750. Therefore, when there are two or more sides including a measure point on the outline of the graphic region, the position of the graphic region may be specified. Thus, an interfacing object indicating that the measurement distance is valid for specifying the position of the graphic region may be added to the interface.

According to an embodiment, the operation of determining whether the position of the graphic region within the garment pattern is specified may include an operation of determining whether each side of the outline of the graphic region includes a measure point when the graphic region, which is rectangular, is not aligned with the first axis and the second axis.

A case in which the rectangular graphic region is not aligned with the first axis and the second axis may be a case in which each side of the rectangular graphic region is not parallel to both the first axis and the second axis. For example, when the first axis is perpendicular to the second axis and the graphic region is rotated by an angle that is not a multiple of 90 degrees, it may be determined that the graphic region is not aligned with the first axis and the second axis.

When the rectangular graphic region is not aligned with the first axis and the second axis, at least four measurement distances may be required to determine a measure point on each side of the graphic region so that the position of the graphic region in the garment pattern is specified. When all four sides of the outline of the graphic region include points that intersect a stored measurement line segment, it may be determined that a measurement distance is valid for specifying the position of the graphic region, and an interfacing object indicating that the measurement distance is valid for specifying the position of the graphic region may be added to the interface. When any of the four sides of the outline of the graphic region does not include a point that intersects the stored measurement line segment, it may be determined that the measurement distance is invalid for specifying the position of the graphic region, and the interfacing object 710 indicating that the measurement distance is invalid for specifying the position of the graphic region may be added to the interface.

According to an embodiment, the operation of displaying the result of determining whether the position of the graphic region in the garment pattern is specified may include an operation of displaying, based on the result of determining whether the position of the graphic region is specified, measure point information for specifying the position of the graphic region in the garment pattern.

When it is determined that the position of the graphic region in the garment pattern is not specified, candidates for the position of the measure point required to specify the position of the graphic region in the garment pattern may be suggested. For example, when the first measure point 721 within the outline of the garment pattern is determined, a point (e.g., the point 751) at which a measurement line segment intersecting a side other than the top side of the graphic region may be generated to specify the position of the graphic region in the garment pattern may be displayed as a candidate for the measure point within the outline of the pattern.

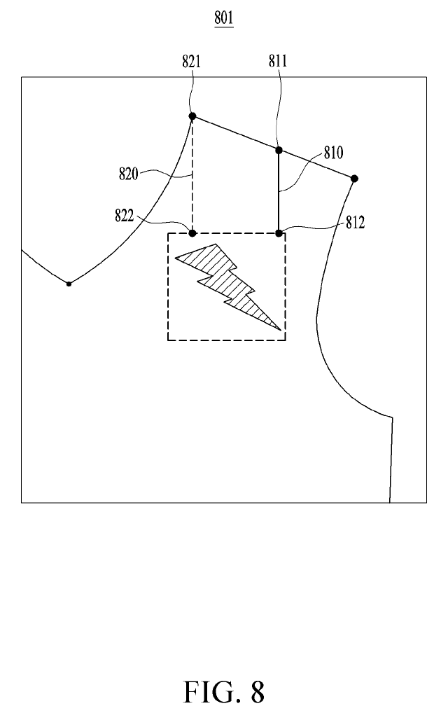

FIG. 8 is a diagram illustrating an operation of updating a measure point by changing a measurement line segment, according to an embodiment.

Referring to a screen 801 of FIG. 8, a first measurement line segment 810 may be determined by an input of selecting a first measure point 811 within an outline of a garment pattern or a second measure point 812 in a graphic region.

A measure point within the outline of the garment pattern and a measure point in the graphic region may be changed by the input of changing the first measurement line segment 810. For example, the first measurement line segment 810 may be changed to a second measurement line segment 820 by an input of changing the first measurement line segment 810 to the second measurement line segment 820 (e.g., an input of changing a position by dragging the first measurement line segment 810).

When the first measurement line segment 810 is changed to the second measurement line segment 820, the measure point within the outline of the garment pattern intersecting the second measurement line segment 820 may be changed to the point 821 on the outline of the garment pattern. The measure point in the graphic region may be changed to the point 822 on the outline of the graphic region intersecting the second measurement line segment 820.

For example, when an input of changing the position of the first measurement line segment 810 includes a mouse input of dragging the first measurement line segment 810, the mouse input may be snapped to a feature point extracted from the outline of the garment pattern. For example, when the first measurement line segment 810 is dragged in a direction close to the point 821 on the outline of the graphic region that corresponds to a feature point and the distance between the position to which the first measurement line segment 810 is moved and the point 821 is less than or equal to a threshold distance, the mouse input may be snapped to the position of the point 821.

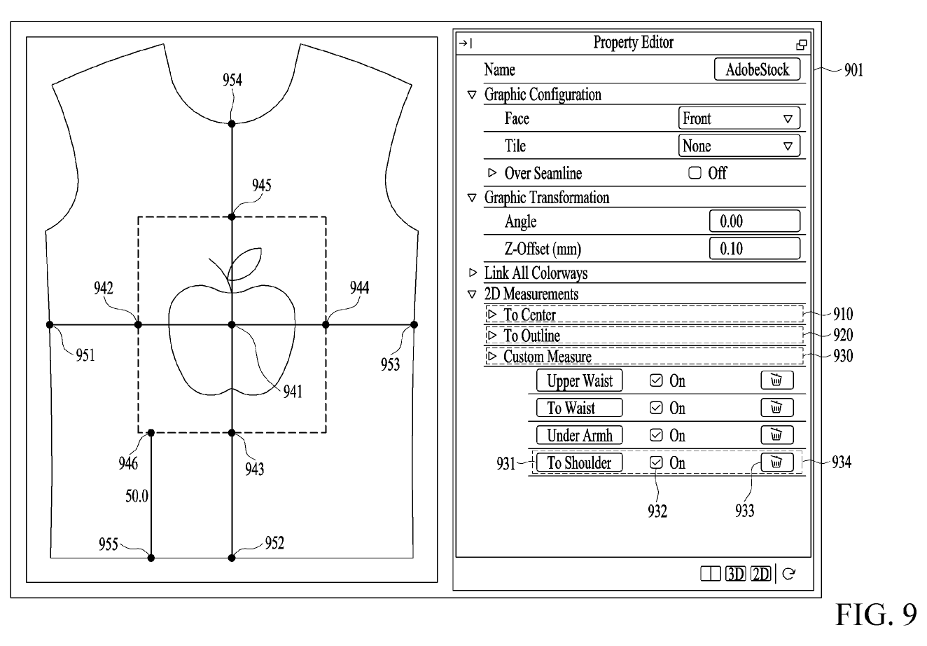

FIG. 9 is a diagram illustrating a settings window of a graphic region, according to an embodiment.

Referring to FIG. 9, a settings window 901 of a graphic region may include an input window for setting the arrangement of a graphic region in a garment pattern and an input window for setting a measurement distance between an outline of the garment pattern and the graphic region.

For example, when the graphic region is disposed on the garment pattern or a user input of selecting the graphic region is received, the settings window 901 of the graphic region may be displayed. For example, when a user input for determining a measure point is received, the settings window 901 of the graphic region may be displayed. The user input of determining a measure point may include, for example, an input of clicking a determined button of an input device (e.g., a mouse, a keyboard, etc.) at a point on the outline of a garment pattern.

Referring to FIG. 9, a request for measuring the distance between the graphic region and the outline of the garment pattern may be input through the settings window 901 of the graphic region.

For example, when an input of selecting a first item 910 for measuring a distance is received in the settings window 901, a request for measuring the distance between the center of the graphic region and the outline of the garment pattern may be input. In this case, a measure point in the graphic region may be determined as a center point 941 of the graphic region. A first measurement line parallel to the x-axis may be generated at the measure point in the graphic region determined as the center point 941 of the graphic region, and points 951 and 953 on the outline of the garment pattern intersecting the first measurement line may be determined as measure points within the outline of the garment pattern. A second measurement line parallel to the y-axis may be generated at the measure point in the graphic region determined as the center point 941 of the graphic region, and points 952 and 954 on the outline of the garment pattern may be determined as measure points within the outline of the garment pattern. The distance between the measure point in the graphic region and the measure point within the outline of the garment pattern may be measured, and the measured distance may be output through an interface.

For example, when an input of selecting a second item 920 for measuring a distance is received in the settings window 901, an input of measuring the distance from a point on the outline of the graphic region intersecting a straight line passing through the center of the graphic region and parallel to the x-axis and the y-axis to the outline of the garment pattern may be input. In this case, the measure point in the graphic region may be determined as points 942 and 944 on the outline of the graphic region intersecting a straight line passing through the center of the graphic region and parallel to the x-axis and points 943 and 945 on the outline of the graphic region intersecting a straight line passing through the center of the graphic region and parallel to the y-axis. In other words, when the graphic region is a rectangle, the points 942, 943, 944, and 945 positioned at the center of the sides of the rectangle, respectively, may be determined as measure points in the graphic region.

The first measurement line may be generated at the determined measure point in the graphic region, and points 951 and 953 on the outline of the garment pattern intersecting the first measurement line may be determined as measure points within the outline of the garment pattern. A second measurement line may be generated at a measure point in the graphic region that is determined as the center of the graphic region, and points 952 and 954 on the outline of the garment pattern intersecting the second measurement line may be determined as measure points within the outline of the garment pattern. The distance between the measure point in the graphic region and the measure point within the outline of the garment pattern may be measured, and the measured distance may be output through an interface.

For example, when an input of selecting a third item 930 for measuring a distance is received in the settings window 901, a point 946 selected by a user input may be determined as a measure point in a first-type entity included in the garment pattern. As described above, when a point in the graphic region is selected as a measure point by a user input, the first-type entity may be determined as the graphic region. When a point on the outline of the garment pattern is selected as a measure point by a user input, the first-type entity may be determined as the outline of the garment pattern.

As described above with reference to FIG. 1, a measure point in a second-type entity included in the garment pattern may be determined, wherein the measure point intersects a straight line passing through a measure point in the first-type entity and parallel to a predetermined axis. For example, a point 955 on the outline of the garment pattern intersecting a straight line passing through the selected point 946 and parallel to the y-axis may be determined as the measure point in the second-type entity. The measurement distance between the measure point in the first-type entity and the measure point in the second-type entity may be output.

An item for setting the measurement distance determined through each item for measuring a distance may be displayed. For example, an item for setting a measurement distance may include a measurement distance name input window 931, a setting input window 932 for determining whether to display a measurement distance, and a setting input window 933 for determining whether to delete a measurement distance.

For example, the name of each measurement distance determined through the measurement distance name input window 931 may be input. A user may determine a name to identify a measurement distance by inputting the name (e.g., "To Shoulder") of the measurement distance to the name input window 931.

For example, whether to display the determined measurement distance may be determined through the setting input window 932 for determining whether to display the measurement distance. When it is set to display the measurement distance, the measurement distance may be output through the interface on which the garment pattern and the graphic region are displayed. When it is set to display the measurement distance, the measure point in the graphic region and the measure point within the outline of the garment pattern may also be displayed through the interface on which the garment pattern and the graphic region are displayed. When it is set to display the measurement distance, a measurement line segment connecting the measure point in the graphic region to the measure point within the outline of the garment pattern may be displayed through the interface on which the garment pattern and the graphic region are displayed. When it is set not to display the measurement distance, the measurement distance may not be output through the interface on which the garment pattern and the graphic region are displayed.

For example, whether to delete the determined measurement distance may be determined through the setting input window 933 for determining whether to delete the measurement distance. When it is set to delete the measurement distance, information on the stored measurement distance may be deleted. When it is set to delete the measurement distance, an item 934 associated with the measurement distance may also be deleted.

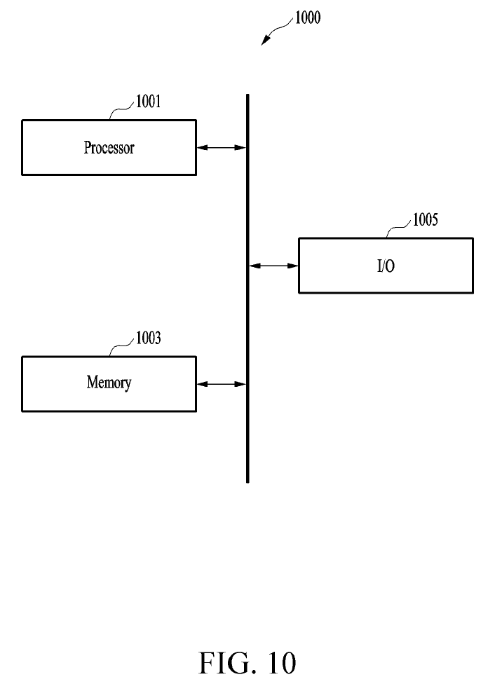

FIG. 10 is an example of a configuration of an apparatus according to an embodiment.

Referring to FIG. 10, an apparatus 1000 according to an embodiment may be an electronic apparatus including a processor 1001, a memory 1003, and an input/output (I/O) device 1005. The apparatus 1000 according to an embodiment may include an apparatus for performing the method of measuring a position of a graphic disposed on a garment pattern described above with reference to FIGS. 1-9. For example, the apparatus 1000 may include at least one of a server and a user terminal (e.g., a personal computer (PC), a mobile phone, a tablet, a wearable device, etc.).

The processor 1001 according to an embodiment may perform at least one operation included in the method of measuring the position of the graphic disposed on the garment pattern described above with reference to FIGS. 1-9. For example, the processor 1001 may perform at least one of an operation of determining a measure point in a first-type entity included in a garment pattern, an operation of determining a measure point in a second-type entity included in the garment pattern, wherein the measure point intersects a straight line parallel to a predetermined axis passing through the measure point in the first-type entity, and an operation of outputting a measurement distance between the measure point in the first-type entity and the measure point in the second-type entity.

The memory 1003 according to an embodiment may be a volatile memory or a non-volatile memory and may store data related to the method of measuring the position of the graphic disposed on the garment pattern described above with reference to FIGS. 1-9. For example, the memory 1003 may store data generated during the process of performing the method of measuring the position of the graphic disposed on the garment pattern described above with reference to FIGS. 1-9 or data required to perform the method of measuring the position of the graphic disposed on the garment pattern described above with reference to FIGS. 1-9. For example, the memory 1003 may store information about a determined measure point and a measurement distance.

According to an embodiment, the memory 1003 may not be a component of the apparatus 1000 and may be included in an external device accessible by the apparatus 1000. In this case, the apparatus 1000 may receive data stored in the memory 1003 included in the external device and transmit data to be stored in the memory 1003 via a communication device.

According to an embodiment, the memory 1003 may store a program implementing the method of measuring the position of the graphic disposed on the garment pattern described above with reference to FIGS. 1-9. The processor 1001 may execute the program stored in the memory 1003 and control the apparatus 1000. Code of the program executed by the processor 1001 may be stored in the memory 1003.

For example, the memory 1003 may store instruction(s). The instruction(s) stored in the memory 1003, when executed by the processor 1001, may cause the apparatus 1000 to perform the operation of determining the measure point in the first-type entity included in the garment pattern, the operation of determining the measure point in the second-type entity included in the garment pattern, wherein the measure point intersects the straight line parallel to the predetermined axis passing through the measure point in the first-type entity, and the operation of outputting the measurement distance between the measure point in the first-type entity and the measure point in the second-type entity.

The I/O device 1005 according to an embodiment may include an input device and an output device. A user input for determining a measure point may be received through the I/O device 1005, and the measurement distance may be output.

The apparatus 1000 according to an embodiment may further include other components not shown in the drawings. For example, the apparatus 1000 may further include a communication device for communicating with other devices (e.g., a server, a terminal, a network, etc.). In another example, the apparatus 1000 may further include other components such as a transceiver, various sensors, and a database.

The embodiments described herein may be implemented using a hardware component, a software component and/or a combination thereof. For example, the devices, the methods, and the components described in the embodiments may be implemented using a general-purpose or special-purpose computer, such as a processor, a controller and an arithmetic logic unit (ALU), a digital signal processor (DSP), a microcomputer, a field programmable gate array (FPGA), a programmable logic unit (PLU), a microprocessor, or any other devices capable of responding to and executing instructions. A processing device may run an operating system (OS) and one or more software applications that run on the OS. The processing device may also access, store, manipulate, process, and generate data in response to execution of the software. For purpose of simplicity, the description of the processing device is used as singular; however, one skilled in the art will appreciate that the processing device may include a plurality of processing elements and/or multiple types of processing elements. For example, the processing device may include a plurality of processors or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a computer-readable storage medium.

The method according to the embodiments described above may be recorded in the computer-readable storage medium including program instructions to implement various operations of the embodiments described above. The computer-readable storage medium may also include, alone or in combination with the program instructions, data files, data structures, and the like. The program instructions recorded on the medium may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as ROM, random access memory (RAM), flash memory, and the like. Examples of program instructions include both machine code, such as one produced by a compiler, and files containing higher-level code that may be executed by the computer using an interpreter.

The hardware devices described above may be configured to act as one or more software modules in order to perform the operations of the embodiments described above, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method of measuring a position of a graphic disposed on a garment pattern, the method comprising:
determining a measure point in a first-type entity included in a garment pattern;
determining a measure point in a second-type entity included in the garment pattern, wherein the measure point in the second-type entity intersects a straight line parallel to a predetermined axis passing through the measure point in the first-type entity; and
outputting a measurement distance between the measure point in the first-type entity and the measure point in the second-type entity,
wherein, when the first-type entity is a graphic region, the second-type entity comprises an outline of the garment pattern, and
wherein, when the first-type entity is the outline of the garment pattern, the second-type entity comprises the graphic region.

2. The method of claim 1, wherein:
the determining of the measure point in the first-type entity comprises determining, based on a user input of selecting a point on the outline of the garment pattern, the selected point as the measure point in the first-type entity,
the first-type entity is determined as the outline of the garment pattern, and the second-type entity is determined as the graphic region.

3. The method of claim 1, wherein:
the determining of the measure point in the first-type entity comprises determining, based on a user input of selecting a point in the graphic region, the selected point as the measure point in the first-type entity,
the first-type entity is determined as the graphic region, and the second-type entity is determined as the outline of the garment pattern.

4. The method of claim 1, wherein:
the determining of the measure point in the first-type entity comprises determining a feature point extracted from the outline of the garment pattern as the measure point in the first-type entity,
the first-type entity is determined as the outline of the garment pattern, and the second-type entity is determined as the graphic region.

5. The method of claim 1, wherein a measure point in an entity of a type corresponding to the graphic region comprises at least one of:
a point on an outline of the graphic region; and
a point in a graphic content region in the graphic region.

6. The method of claim 1, wherein at least one of the measure point in the first-type entity, the measure point in the second-type entity, and the measurement distance is stored in a memory corresponding to the garment pattern.

7. The method of claim 1, further comprising:
storing an offset of a measure point in an entity of a type corresponding to the graphic region from a reference position in the graphic region;
after at least one of a position and a size of the graphic region is changed, updating the measure point in the entity of the type corresponding to the graphic region from the reference position to a point corresponding to the stored offset;
based on the updated measure point in the entity of the type corresponding to the graphic region, updating a measure point in an entity of a type corresponding to the outline of the garment pattern; and
outputting an updated measurement distance between the measure point of the first-type entity and the measure point in the second-type entity.

8. The method of claim 7, wherein a change in the position of the graphic region comprises at least one of translation of the graphic region and rotation of the graphic region.

9. The method of claim 7, wherein, when the graphic region is translated, the measure point in the entity of the type corresponding to the graphic region remains unchanged.

10. The method of claim 7, wherein, when the graphic region is rotated, the measure point in the entity of the type corresponding to the outline of the garment pattern remains unchanged.

11. A non-transitory computer-readable storage medium storing instructions thereon, the instructions, when executed by at least one processor cause the at least one processor to:
determine a measure point in a first-type entity included in a garment pattern;
determine a measure point in a second-type entity included in the garment pattern, wherein the measure point intersects a straight line parallel to a predetermined axis passing through the measure point in the first-type entity; and
output a measurement distance between the measure point in the first-type entity and the measure point in the second-type entity,
wherein, when the first-type entity is a graphic region, the second-type entity comprises an outline of the garment pattern, and
wherein, when the first-type entity is the outline of the garment pattern, the second-type entity comprises the graphic region.

12. An electronic apparatus comprising:
at least one processor; and
a memory storing instructions, the instructions, when executed by the at least one processor, cause the electronic apparatus to perform:
determining a measure point in a first-type entity included in a garment pattern;
determining a measure point in a second-type entity included in the garment pattern, wherein the measure point intersects a straight line parallel to a predetermined axis passing through the measure point in the first-type entity; and
outputting a measurement distance between the measure point in the first-type entity and the measure point in the second-type entity,
wherein, when the first-type entity is a graphic region, the second-type entity comprises an outline of the garment pattern, and
wherein, when the first-type entity is the outline of the garment pattern, the second-type entity comprises the graphic region.

13. The electronic apparatus of claim 12, wherein:
the determining of the measure point in the first-type entity comprises determining, based on a user input of selecting a point on the outline of the garment pattern, the selected point as the measure point in the first-type entity,
the first-type entity is determined as the outline of the garment pattern, and the second-type entity is determined as the graphic region.

14. The electronic apparatus of claim 12, wherein:
the determining of the point in the first-type entity as the measure point comprises determining, based on a user input of selecting a point in the graphic region, the selected point as the measure point in the first-type entity,
the first-type entity is determined as the graphic region, and the second-type entity is determined as the outline of the garment pattern.

15. The electronic apparatus of claim 12, wherein:
the determining of the point in the first-type entity as the measure point comprises determining a feature point extracted from the outline of the garment pattern as the measure point in the first-type entity,
the first-type entity is determined as the outline of the garment pattern, and the second-type entity is determined as the graphic region.

16. The electronic apparatus of claim 12, wherein a measure point in an entity of a type corresponding to the graphic region comprises at least one of:
a point on an outline of the graphic region; and
a point in a graphic content region in the graphic region.

17. The electronic apparatus of claim 12, wherein at least one of the measure point in the first-type entity, the measure point in the second-type entity, and the measurement distance is stored corresponding to the garment pattern.

18. The electronic apparatus of claim 12, wherein the instructions, when executed by the at least one processor, cause the electronic apparatus to further perform:
storing an offset of a measure point in an entity of a type corresponding to the graphic region from a reference position in the graphic region;
after at least one of a position and a size of the graphic region is changed, updating the measure point in the entity of the type corresponding to the graphic region to a point corresponding to the offset stored from the reference position;
based on the measure point in the entity of the type corresponding to the graphic region, updating a measure point in an entity of a type corresponding to the outline of the garment pattern; and
outputting an updated measurement distance between the measure point of the first-type entity and the measure point in the second-type entity.

19. The electronic apparatus of claim 18, wherein a change in the position of the graphic region comprises at least one of translation of the graphic region and rotation of the graphic region.

20. The electronic apparatus of claim 18, wherein,
when the graphic region is translated, the measure point in an entity of a type corresponding to the graphic region remains unchanged, and
when the graphic region is rotated, the measure point in an entity of a type corresponding to the outline of the garment pattern remains unchanged.
